(19) United States
(12) Patent Application Publication
(10) Pub. No.: US 2004/0154413 A1
(43) Pub. Date: Aug. 12, 2004

(54) Monitoring system

(76) Inventors: Joanne Coy, London (GB); Robert Parkin, Lougborough (GB); Luca Notini, Loughborough (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/473,531

(22) PCT Filed: Mar. 28, 2002
(86) PCT No.: PCT/GB02/01577

(30) Foreign Application Priority Data
Mar. 29, 2001 (GB) 0107900.3

(51) Int. Cl. G01L 1/04

(52) U.S. Cl. 73/862.453

(57) ABSTRACT

A system for monitoring a machine (10) comprises a number of strategically placed sensing devices (11, 12, 13, 14) which are arranged to detect particular physical characteristics, such as vibration, thermal energy etc. Output signals from the sensing devices are delivered to a processor (15) which combines them to produce control signals indicative of the condition of a particular part or parts of the machine. In this way, the health of the machine can be continously monitored.

This invention relates to systems for monitoring machinery having relatively-moving parts, such as mail sorting machines.

Machines such as mail sorters have a relatively high throughput and are required repeatedly to operate for long periods of time. Any downtime for maintenance or repair of such machines needs to be properly controlled and kept to a minimum. The present invention has been developed with that aim in mind.

According to the invention there is provided a system for monitoring a machine having relatively-moving parts, comprising at least two sensing means each arranged to detect a particular physical characteristic or characteristics, such as vibration and/or heat, and control means for receiving signals from said sensing means and processing said signals in combination to produce a control signal indicative of the condition of a particular part or parts of the machine.

The invention also provides a method of monitoring a machine comprising the steps of using at least two sensing devices to detect a particular physical characteristic or characteristics, such as vibration and/or heat, and processing the signals from said sensing devices in combination to produce a control signal indicative of the condition of a particular part or parts of the machine.

The sensing means will preferably be arranged to detect two or more different physical characteristics to provide complementary sensing signal data and lead to a more reliable indication of machine health.

The invention also provides a system for monitoring a belt in a belt and pulley arrangement comprising means for detecting rotational movement of the at least two pulleys about which the belt is trained, means for detecting movement of the belt around the pulleys, and means for receiving signals from said detecting means and processing said signals in combination to determine the extent of any belt slip.

The invention further provides a system for monitoring a belt in a belt and pulley arrangement, comprising first and second means for detecting a physical characteristic associated with the belt, eg acoustic vibration, in which said first and second detecting means are arranged generally to either side of a span of the belt, whereby signals generated by said detecting means in use can be subtracted one from the other in order to cancel out extraneous background signals.

The invention further provides a system for monitoring a belt in a belt and pulley arrangement, comprising means for emitting and means for detecting a signal, eg infra-red light, in which the signal emitting and detecting means is or are mounted in a fixed position relative to the belt, the detecting means to detect signals from the emitting means after reflection by a surface of the belt, and in which the signal from the emitting means is alternatively directed and not directed at the belt, whereby the signals detected by the detecting means at those alternate times can be subtracted one from the other in order to cancel out extraneous background signals.

The term belt and pulley arrangement used herein is intended to include not only mechanisms where belts are used to transfer rotational drive from one shaft to another, but also conveyor belt assemblies where a belt is trained over a number of journalled spindles.

By way of example, embodiments of the invention will now be described with reference to the accompanying drawings, in which:

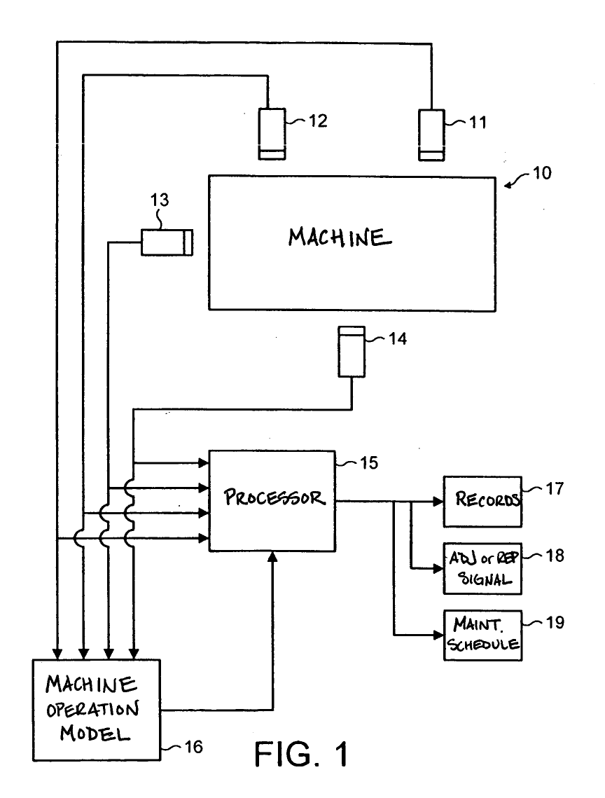

FIG. 1 is a schematic illustration of a machine monitoring system according to the invention,

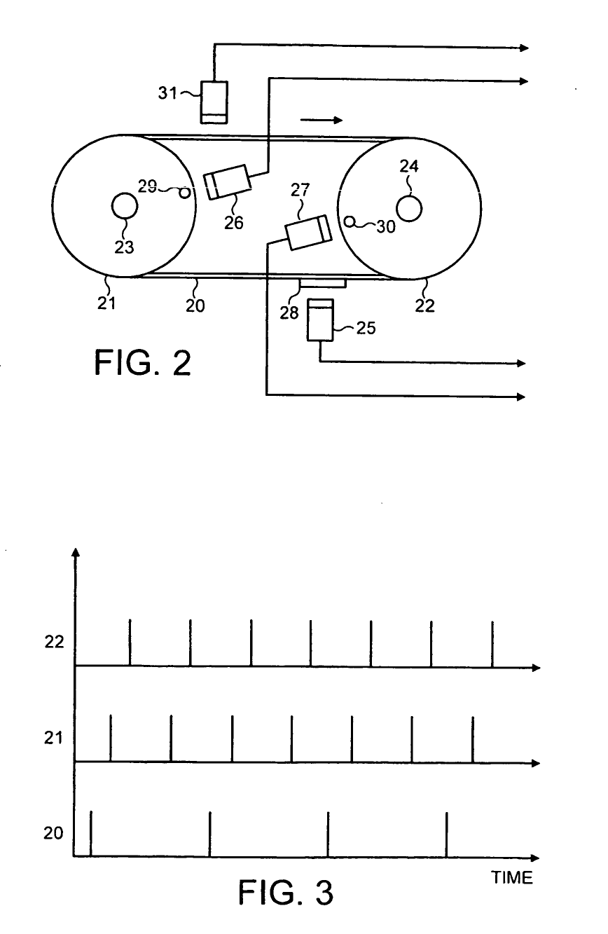

FIG. 2 is a schematic illustration of a belt monitoring system according to the invention,

FIG. 3 is a typical illustration of the output signals from the various sensing devices of the FIG. 2 system,

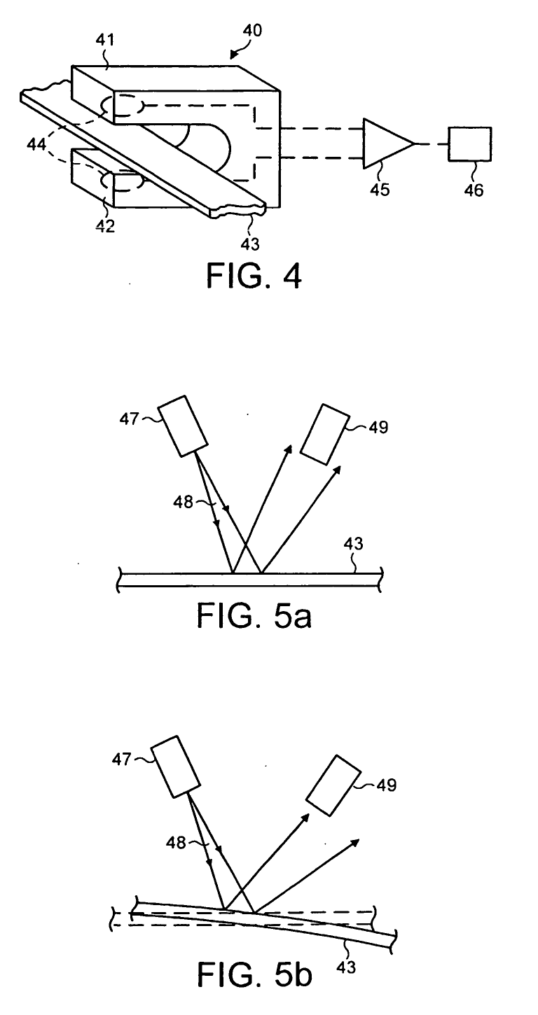

FIG. 4 is a schematic illustration of a belt tension monitoring system, and

FIG. 5a and 5b are schematic illustrations showing an alternative form of belt tension monitoring system.

In FIG. 1, numeral 10 indicates a machine, such as a mail sorting machine. The machine has a large number of relatively-moving parts, such as belts and pulleys, shafts and bearings and so on. It also has a large number of electrical and electronic components, such as motors, printed circuits boards and so on, together with numerous connections therebetween. The machine will typically be required to sort tens of thousands of letters that pass through it each day.

A system for monitoring the various parts and components of the machine comprises a number of sensing devices 11, 12, 13, 14. These are arranged to detect particular physical characteristics at strategic points in and/or around the machine. Sensing device 11 is an accelerometer, which detects vibration. It can be placed near a belt and pulley, for example, and arranged to detect lower frequency signals (less than 25 kHz), which are indicative of problems caused by pulley misalignment, belt looseness or general advanced stages of wear.

The general principle behind vibration monitoring is that energy is supplied to the machine, some of which is dissipated as vibrations. The spectral content of these vibrations will depend upon the energy input and the resonant frequencies of different parts of the machine. If the machine's condition changes due to any reason, the resonant frequencies of the machine and hence the vibrations will change. The vibrations will also change, however, if the input energy changes: for example if a belt becomes loose. Vibrations can be measured by attaching acceleration transducers to different parts of the machine and vibrations can be measured in orthogonal directions. Vibration monitoring produces continuous signals; detecting fault related phenomena therefore requires frequency domain analysis.

It has been found that whereas vibration monitoring can be useful in situations where damage is already quite severe, it is less effective in predicting the onset of faults. Fault conditions, and in particular pre-cursors to fault conditions, result in energy losses. In bearings, spindles and other moving parts, it has been found that energy losses are more effectively detected by acoustic methods, eg acoustic emission, and infra red sensors.

Sensing device 12 is a sound probe which detects acoustic emissions. It can be set to detect relatively high frequency acoustic emissions (higher than 50 kHz), which are indicative of wear in the rolling contact of a bearing.

Monitoring acoustic emission effects equates to detecting high frequency (between 50 kHz and 1 MHz) structure borne activity. This bandwidth corresponds to the signals emitted by energy loss mechanisms typically caused by damage and wear. Theoretically, confining the detection range to such a high frequency band should minimise perturbations caused by extraneous and irrelevant noise sources. However, one disadvantage with acoustic emission is that signal levels decrease with increasing frequency: the transducers have to be very sensitive.

Acoustic emission monitoring produces signals that are non-stationary. However, these signals are currently processed in the time domain (conveniently using statistical moments), resulting in parameters such as distress, a summation of energy loss signals which is sensitive to many faults, or dB, a measure of the mean level of the high frequency signal. For fault analysis, this is a relative measure as values are dependent upon machine speed, type etc.

Sensing device 13 is a thermal imager, which detects infra red light. The amount of infra red light that a body emits is an indication of its temperature and the infra red emission increases with a rise in the body's temperature. A thermal imager can therefore be used to give a view of heat distribution and thereby help to pinpoint hotspots caused for example by advanced wear in bearings or failures in circuit boards or electrical connections.

Sensing device 14 is an acoustic microphone, which detects acoustic resonance. Acoustic resonance is a phenomenon associated with natural frequencies of vibration. The natural frequency of vibration of a belt span is directly related to the tension in the belt. Thus, an acoustic microphone can be used to monitor belt tension.

The relationship between belt tension (T) and frequency of vibration (f) is calculated from knowing the mass per unit length of the belt (m) and the belt span (1), using the expression:

T=4 ml²f²

where T is in Newtons, f in Hertz, 1 in metres and m in Kg/metre. However, as the belt does have some flexural stiffness, the predicted tension for a given frequency will be slightly greater than the actual tension. This is most noticeable on short belt spans, where the belt bending stiffness is the greatest.

The monitoring system operates by having a hardware configuration that places two sensing devices either side of the belt. These sensing devices are usually acoustic microphones. The signal from one is subtracted from the signal of the other, thus taking advantage of superposition effects. In this way, the readings are extremely robust. However, where excessive ambient noise is considered to be potentially problematic, optical sensors are used.

Different belts are comprised of different materials and are manufactured by different means. Each belt type, therefore, has its own peculiar set of deterioration characteristics. Moreover, deterioration rates and failure mechanisms can be affected by exposure to UV light, ozone and more usual ambient conditions such as temperature and humidity. Ideally, such factors are taken into account in the characterisation of failure mechanisms in transport and drive belts in order to produce reliable predictive results.

Alternative arrangements for monitoring belt tension are shown in FIGS. 4 and 5. FIG. 4 shows an acoustically-based system. This is preferred where access to both sides of the belt is available and where higher frequencies (from shorter, tighter belts) are expected. A sensor head 40 in the general shape of a tuning fork is arranged with its two prongs 41, 42 to either side of the belt 43. A high performance electret microphone capsule 44 is mounted in each prong. The microphone capsules 44 detect acoustic signals generated by vibrations of the belt 43. The frequency of such vibrations is a measure of the tension of the belt, on the same principle as the tension in the string of a guitar determines its pitch. The signals from the two capsules 44 are combined, at reference numeral 45 in the drawing, to produce, at reference numeral 46, an indication of belt tension.

Acoustic signals detected by the capsules 44 will of course incorporate background “noise” as well as vibration signals from the belt 43 itself By subtracting one signal from the other, however, this background “noise” can be effectively eliminated, giving a measure of belt vibration and hence tension. In algebraic terms, the signal from one capsule can be represented as n+p, where n is background “noise” and p is belt vibration, and the signal from the other capsule will be n−p. Subtracting the latter from the former gives 2p, ie n is cancelled out.

FIGS. 5a and 5b illustrate an optically-based system. This is favoured where access to the belt 43 is restricted or where lower frequencies (from longer, slacker belts) are involved. The arrangement comprises an infra-red emitting diode 47 which directs an unfocussed infra-red light beam 48 onto the outer surface of the belt 43. An infra-red sensitive photodiode 49 is arranged to detect reflected infra-red light from the belt surface. As illustrated diagrammatically in FIG. 5b, when the belt 43 vibrates and its curvature changes, the infra-red light reflected from its surface changes direction, causing less light to fall on the photodiode 49. The change in light intensity received by the photodiode 49 gives a measure of the amount of flexure of the belt 43, which in turn gives an indication of its tension.

As with the FIG. 4 system, there will be a degree of background “noise”, ie light from other sources picked up by the photodiode 49. The problem of such background “noise” is minimised by the use of infra-red light as the measuring medium, since in practice there will generally be less extraneous light around in the infra-red spectrum than in the visible light spectrum. In normal situations, the only source of background “noise” in this system is likely to be from discharge lighting. To deal with the background “noise”, a cancellation technique is used which is known as “synchronous demodulation”. According to this technique, the emitter 47 is switched on and off at a rapid rate, typically at a frequency of 20 kHz. During the off period, the detector 49 senses only background “noise”, whereas during the on period, it will detect both background “noise” and the signal 48 from the emitter 47 as reflected by the belt 43. By subtracting one signal from the other in a similar manner to the FIG. 4 system, the background “noise” is effectively eliminated, leaving just signals from the reflected beam.

Other sensing devices that could be used include gas samplers for detecting leakages of gas or fluid or gases produced by chemical reactions, particle samplers for detecting debris from wearing parts, cameras for making visual inspections, thermostatic sensors (other than infra red) for heat detection and texture sensors for identifying changes in surface texture.

A variety of sensing devices are located at strategic points around the machine. These may be mounted on the machine itself or in a fixed position relative to the machine or a combination of both. Alternatively, or additionally, sensing devices may be used that are movable, for example robotically, either automatically or on command. Some sensing devices may even be encapsulated in a package that is able to pass through the machine itself.

The sensing devices are all arranged to communicate their output data to a processor 15. This can be achieved by a number of alternative means, including telemetry, connection to a CAN BUS, connection to a field BUS or a hub connection arrangement. Ideally, the output data from the sensing devices will be acquired automatically by the processor without need of manual intervention, and on a continuous basis.

The various sensing devices are advantageously arranged to work together in combinations of two or more, giving data signals relating to two or more different physical characteristics for analysis. This provides complementary information from which it is possible to make a more accurate determination than with information from individual detector sources. For example, an acoustic emission sensor may indicate a high degree of friction in a particular pulley assembly, suggesting a number of possible root causes. An infra red thermal imaging sensor aimed at the assembly may show that heat is being generated on the pulley at a location that coincides with its point of contact with the belt. However, an acoustic resonance sensor set up to monitor belt tension may indicate that the belt is not over-tensioned. From a combination of this information from these three sensing devices, it is possible to conclude that the problem in this particular pulley assembly is caused by misalignment.

The output from the processor 15 will be a control signal resulting from the fault diagnosis and this will typically indicate when a particular part or parts requires adjustment or is expected to need replacement.

A belt monitoring system is illustrated in FIGS. 2 and 3. A typical pulley and belt arrangement is seen in FIG. 2 in which belt 20 is trained around pulleys 21 and 22, which are keyed to shafts 23 and 24, in order to transfer rotational drive from one shaft to the other in conventional manner. Arranged near the belt and each of the pulleys is a respective sensing device 25, 26, 27. These are designed to monitor the movements of the belt and pulleys and they do so by detecting indicators 28, 29, 30 on these components. These indicators may take any suitable form so as to stand out from the components themselves, for example, optical or magnetic markers. The sensing devices are able to detect when their respective indicators pass by, and produce a signal in consequence.

FIG. 3 illustrates the signals that may typically be received from each sensing device 25, 26, 27 in the belt and pulley arrangement of FIG. 2, with pulley 22 being the drive pulley and pulley 21 the driven pulley. The pulses in the output signals from each sensing device indicate the passing of its respective indicator. Each pulse from the belt sensing device 25 therefore indicates when the full length of the belt 20 has completed a circuit around its path, whilst each pulse from each of the pulley sensing devices 26, 27 indicates the completion of a full revolution of its respective pulley 21 , 22.

These output signals are also fed to processor 15, where they are analysed in relation to each other and in relation to the signals from the other sensing devices and processed to produce control signals which give an indication of belt slip. The information on belt slip may typically be derived through an analysis of the phase relationship between the pulses of the various sensing device output signals.

The system may incorporate more than three sensing devices. For example, it may be preferable to arrange two sensing devices to monitor the belt: one 31 on its tight side, ie over the span which delivers drive between the pulleys, and the other on its slack side, ie the “return” span.

It may also of course be advantageous to include a number of indicators, rather than just one per component. This would help to increase the sensitivity of the belt monitoring system. Where a plurality of markers is used on the belt, these can be used to obtain information about belt tension and performance. Specifically, the distance between the markers on the belt when the belt is static (or moving very slowly) can be compared with their separation in the dynamic state, to give an indication of the elongation of the belt. The elongation of the belt is related to its tension. These data can be compared between the tight side and the slack side of the belt spans. Conveniently, the plurality of markings may be provided in the form of a single elastomeric strip of material to be applied to the belt, eg by adhesive, with the strip having a series of graduated markings on its surface. The strip is designed to expand (or contract) with the belt so that any variation in the belt length (and hence its tension) can be picked up by the sensing device.

An additional level of sophistication is built into the fault diagnosis function of the processor 15 in that it is programmed also to take into account the output data from the various other sensing devices around the machine, especially those upstream of the particular part or parts at the time being assessed. Obtaining information from all around the machine and viewing the machine holistically enables allowances to be made for occurrences elsewhere, such as breakages, particularly upstream, which can influence what will be detected downstream. By factoring in this additional information, a more reliable prediction can be made, with fewer false alarms as a result.

A further level of sophistication is introduced into the system by the application of artificial intelligence tools, such as fuzzy models, neural networks or intelligent clustering. These are techniques by which information gathered together from the various sensing devices whilst the machine is in operation is used to build up a model 16 of how the machine and its various parts typically operate. A predictive algorithm is used to perform an analysis of the actual data received from the various sensing devices in comparison with model data. Ideally, such a predictive analysis will be carried out continuously in real time and there will be a feedback of data to the processor 15 so that the model will be continuously updated and refined. In time, a reliable picture will be built up of the more critical areas of the machine and the likely lifespan of the various machine parts in these areas.

The monitoring system is conveniently set up to be able to operate autonomously, with only periodic manual intervention. It will ideally produce and maintain historical records 17 for the various machine parts and an automatic signal 18 when adjustments or replacements are required. It will ideally also be able to calculate the best time for adjustments and replacements to be made and produce a suitable maintenance schedule 19 for the machine.

Operating a machine monitoring system such as that described above offers a number of significant advantages. The ability to predict impending replacement when the machine is scheduled to be out of service. The elimination of down time due to machine failure results in increased capacity. More mail is able to be processed and delivery costs are reduced as the number of times mail is handled is minimised. With effective monitoring, peak machine performance can be maintained over the planned operational life of the machine. Deterioration in performance due to fatigue, wear and corrosion can be eliminated.

It is also important to note that ‘knock-on’ deleterious effects upon components emanating from the sub-optimal performance of another component are also eliminated, thus again minimising costs and resource consumption. The identification and timely replacement of parts such as worn belts, bearings and rollers minimise jams during operation: thus throughput is maximised. Additionally, the monitoring and maintenance of appropriate belt tension maximises read rates of both addresses and four state bar codes.

The ability to predict failure of components facilitates the minimising of the spares held on site. Some component parts deteriorate over time when held in storage: the effects of ambient humidity, oxidation and UV light can have deleterious effects. Waste associated with the use of sub perfect components, replacements and servicing these components when in stock can be eliminated.

1. A system for monitoring a machine having relatively-moving parts, comprising at least two sensing means each arranged to detect a particular physical characteristic or characteristics , such as vibration and/or heat, and control means for receiving signals from said sensing means and processing said signals in combination to produce a control signal indicative of the condition of a particular part or parts of the machine.

2. A machine monitoring system as claimed in claim 1 and further comprising analysing means for receiving the control signal from the control means and comparing said control signal with a reference signal to produce a command signal.

3. A machine monitoring system as claimed in claim 2 wherein said reference signal is pre-programmed into the analysing means.

4. A machine monitoring system as claimed in claim 2 or claim 3 wherein said reference signal is derived from control signals previously generated by said system.

5. A machine monitoring system as claimed in any preceding claim wherein said control means and said analysing means operate in real time.

6. A machine monitoring system as claimed in any preceding claim wherein said at least two monitoring means each sense a different physical characteristic.

7. A machine monitoring system as claimed in any preceding claim wherein said monitoring means sense physical characteristics such as vibration, heat, sound, resonance, texture.

8. A machine monitoring system as claimed in any preceding claim and further comprising means mounting said sensing means in relation to said machine.

9. A machine monitoring system as claimed in claim 8 wherein said mounting means is operable to alter the position of said sensing means relative to the machine.

10. A machine monitoring system as claimed in claim 9 wherein said mounting means is operable to alter the position of said sensing means automatically.

11. A system for monitoring a belt in a belt and pulley arrangement, comprising means for detecting rotational movement of the at least two pulleys about which the belt is trained, means for detecting movement of the belt around the pulleys, and means for receiving signals from said detecting means and processing said signals in combination to determine the extent of any belt slip.

12. A belt monitoring system as claimed in claim 11 wherein said detecting means comprises a sensing device arranged to detect an indicator means on each of the belt and pulleys.

13. A belt monitoring system as claimed in claim 12 wherein said indicator means comprises a marker positionable on each of the belt and pulleys.

14. A belt monitoring system as claimed in any one of claims 11 to 13 wherein the detecting means uses optical technology.

15. A belt monitoring system as claimed in any of the claims 11 to 13 wherein the detecting means uses magnetic technology.

16. A belt monitoring system as claimed in any one of claims 11 to 15 wherein said belt movement detecting means is arranged to detect movement of the belt in both its tight span and slack span.

17. A belt monitoring system as claimed in any one of claims 11 to 16 and further comprising means for introducing a reference signal into said signal processing means for comparison with the signals from said detecting means in the said determination of any belt slip.

18. A belt monitoring system as claimed in claim 17 wherein said reference signal is derived from signals received from said detecting means in use of the system.

19. A belt monitoring system as claimed in claim 18 wherein said reference signal is derived and introduced in real time during operation of the system.

20. A belt monitoring system as claimed in any one of claims 11 to 19 wherein said means for detecting movement of the belt comprises indicator means in the form of an elastomeric marker having a plurality of graduated markings thereon, the marker being attachable to the belt so as to expand or contract therewith.

21. A belt monitoring system as claimed in claim 20 wherein detection of said expansion or contraction of the belt and marker is used to determine variations in belt tension.

22. A machine monitoring system as claimed in any one of claims 1 to 10 incorporating a belt monitoring system as claimed in any one of claims 11 to 21.

23. A method of monitoring a machine comprising the steps of using at least two sensing devices to detect a particular physical characteristic or characteristics, such as vibration and/or heat, and processing the signals from said sensing devices in combination to produce a control signal indicative of the condition of a particular part or parts of the machine.

24. A method as claimed in claim 23 wherein said sensing devices comprise thermal imaging devices which detect thermal energy.

25. A method as claimed in claim 23 or 24 and further comprising the step of comparing said control signal with a reference signal to produce a command signal.

26. A method as claimed in claim 25 and further comprising the step of processing said signals from the sensing devices to produce and/or refine said reference signal.

27. A system for monitoring a belt in a belt and pulley arrangement, comprising first and second means for detecting a physical characteristic associated with the belt, eg acoustic vibration, in which said first and second detecting means are arranged generally to either side of a span of the belt, whereby signals generated by said detecting means in use can be subtracted one from the other in order to cancel out extraneous background signals.

28. A system for monitoring a belt in a belt and pulley arrangement, comprising means for emitting and means for detecting a signal, eg infra-red light, in which the signal emitting and detecting means is or are mounted in a fixed position relative to the belt, the detecting means to detect signals from the emitting means after reflection by a surface of the belt, and in which the signal from the emitting means is alternatively directed and not directed at the belt, whereby the signals detected by the detecting means at those alternate times can be subtracted one from the other in order to cancel out extraneous background signals.

29. A machine monitoring system substantially as herein described with reference to the accompanying drawings.

30. A belt monitoring system substantially as herein described with reference to the accompanying drawings.

31. A method of monitoring a machine substantially as herein described with reference to the accompanying drawings.
